(19) United States
(12) Patent Application Publication
(10) Pub. No.: US 2011/0199282 A1
(43) Pub. Date: Aug. 18, 2011

(54) ANTENNA AND PORTABLE APPARATUS

(75) Inventor: Sadatoshi Oishi, Shizuoka-ken (JP)

(73) Assignee: TOSHIBA TEC KABUSHIKI KAISHA, Tokyo (JP)

(21) Appl. No.: 13/027,753

(22) Filed: Feb. 15, 2011

(30) Foreign Application Priority Data
Feb. 16, 2010 (JP) 2010-31629

(51) Int. Cl. H01Q 1/36; H01Q 1/42

(52) U.S. Cl. 343/872; 343/700 MS

(57) ABSTRACT

According to one embodiment, an antenna includes: a disk-shaped radiating element having an opening in a center area and configured to radiate a radio wave; a ground plate configured to support the radiating element and having a surface parallel to the radiating element; and a power feeding element exciting the radiating element, a part of the power feeding element being located on an inner side of the opening when viewed from a predetermined direction orthogonal to a surface on which the radiating element is located.

### CROSS-REFERENCE TO RELATED APPLICATION

This application is also based upon and claims the benefit of priority from Japanese Patent Application No, 2010-31629, filed on Feb. 16, 2010; the entire contents of which are incorporated herein by reference.

### FIELD

Embodiments described herein relate generally to a planar antenna used in a portable RFID (Radio Frequency Identification) reader writer or the like.

### BACKGROUND

There is a composite antenna obtained by combining a circularly polarized antenna and a vertically polarized antenna. There is a micro strip antenna including a conductor plate, a radiating conductor plate arranged in parallel to a bottom surface of the conductor plate, and a power feeding pin for feeding electric power to the radiating conductor plate.

### DESCRIPTION OF THE DRAWINGS

FIG. 1 is a front view of a patch antenna;

FIG. 2 is a sectional view taken along line A-A in FIG. 1 in the patch antenna;

FIG. 3A is a front view of the structure of a rib;

FIG. 3B is a side view of the structure of the rib;

FIG. 4 is a diagram of a distribution of electric currents in the patch antenna;

FIG. 5 is a graph of a frequency characteristic of the patch antenna;

FIG. 6 is a graph of an impedance characteristic of the patch antenna; and

FIG. 7 is an external view of a portable reader writer including the patch antenna.

### DETAILED DESCRIPTION

In general, according to one embodiment, an antenna includes: a disk-shaped radiating element having an opening in a center area and configured to radiate a radio wave; a ground plate configured to support the radiating element and having a surface parallel to the radiating element; and a power feeding element configured to excite the radiating element, a part of the power feeding element being located on an inner side of the opening when viewed from a predetermined direction orthogonal to a surface on which the radiating element is located.

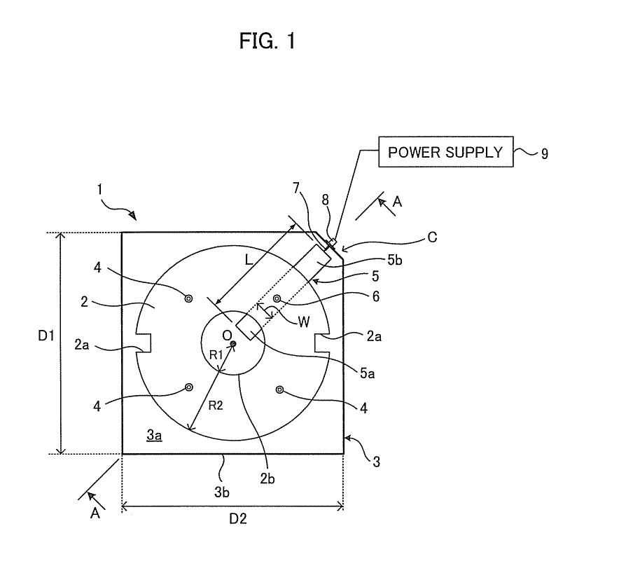

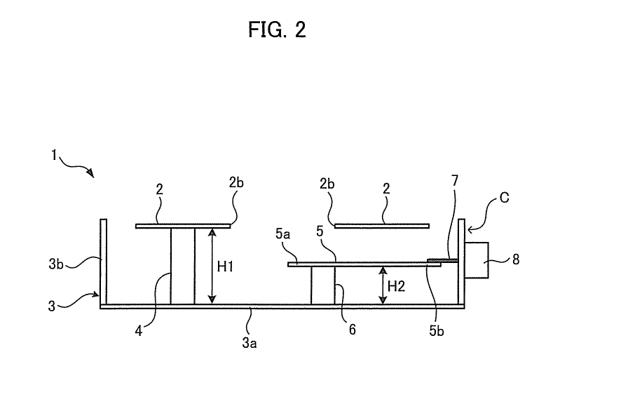

An embodiment is explained below with reference to the accompanying drawings. FIG. 1 is a diagram of a patch antenna according to this embodiment viewed from the front of the patch antenna. FIG. 2 is a sectional view taken along line A-A in FIG. 1.

A patch antenna 1 includes a tabular radiating element 2. The radiating element 2 is formed in a substantially circular shape when viewed from the front of the patch antenna 1. A direction orthogonal to a surface (an imaginary surface) on which the radiating element 2 is located is a direction corresponding to the front of the patch antenna 1.

Two cutouts 2a are formed in the outer circumferential section (the outer edge section) of the radiating element 2. The outer circumferential section of the radiating element 2 excluding the cutouts 2a is formed along a circle. Although the cutouts 2a are formed in this embodiment, the cutouts 2a do not have to be formed. In other words, the radiating element 2 can be formed in a circular shape.

When the patch antenna 1 is viewed from the front, an opening 2b is formed in the center (an area including a center point O) of the radiating element 2. The two cutouts 2a are provided in positions opposed to each other across the opening 2b.

In this embodiment, when the patch antenna 1 is viewed from the front, the radiating element 2 is formed in a substantially circular shape. However, the radiating element 2 can be formed in other shapes. For example, the radiating element 2 can be formed in a regular polygonal shape.

The radiating element 2 is held by a ground plate 3. As shown in FIG. 2, ribs 4 are provided on a bottom surface 3a of the ground plate 3. The ribs 4 extend in a direction orthogonal to the bottom surface 3a. The radiating element 2 is fixed to the distal ends of the ribs 4. In this embodiment, as shown in FIG. 1, the radiating element 2 is supported by three ribs 4.

When the patch antenna 1 is viewed from the front, two ribs 4 are arranged in positions opposed to each other across the opening 2b of the radiating element 2. Another rib 4 is arranged between the two ribs 4 in the circumferential direction of the radiating element 2. The three ribs 4 are arranged on a track of a circle centered on the point O. Since the three ribs 4 are arranged, it is possible to stably support the radiating element 2.

The number and the positions of the ribs 4 for supporting the radiating element 2 can be set as appropriate. Specifically, the radiating element 2 only has to be able to be supported using the ribs 4. The number of the ribs 4 and positions where the ribs 4 are arranged can be set as appropriate.

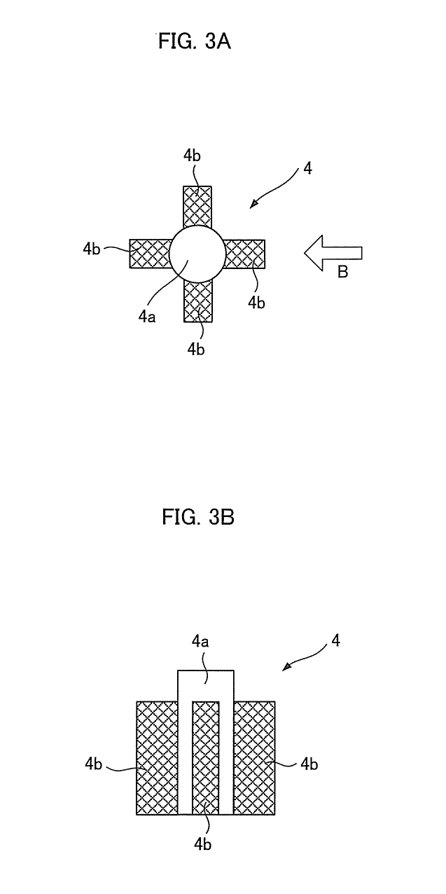

A supporting structure for the radiating element 2 by the ribs 4 is specifically explained with reference to FIGS. 3A and 3B. FIG. 3A is a front view of the rib 4 viewed from the front of the patch antenna 1. FIG. 3B is a side view of the rib 4 viewed from a direction of an arrow B shown in FIG. 3A.

The rib 4 includes a main body 4a formed in a columnar shape and four blades 4b provided on the outer circumferential surface of the main body 4a. The four blades 4b are arranged at equal intervals in the circumferential direction of the main body 4a. Although the four blades 4b are provided in this embodiment, the number of the blades 4b can be set as appropriate.

As shown in FIG. 3B, an area where the blades 4b are not provided is formed at one end of the main body 4a. The one end of the main body 4a is inserted into an opening (not shown) formed in the radiating element 2. Since the one end of the main body 4a is inserted into the opening of the radiating element 2, it is possible to position the radiating element 2 in a direction orthogonal to a longitudinal direction of the main body 4a. Since the radiating element 2 is set in contact with one ends of the blades 4b, it is possible to position the radiating element 2 in the longitudinal direction of the main body 4a.

The radiating element 2 is arranged substantially in parallel to the bottom surface 3a of the ground plate 3 by the ribs 4. As shown in FIG. 2, a space between the radiating element 2 and the bottom surface 3a is set to be a predetermined value H1.

A tabular power feeding element 5 is arranged between the radiating element 2 and the bottom surface 3a of the ground plate 3. The power feeding element 5 is supported by a rib 6. The rib 6 extends in the direction substantially orthogonal to the bottom surface 3a of the ground plate 3. The power feeding element 5 is fixed to the distal end of the rib 6.

A supporting structure for the power feeding element 5 by the rib 6 is the same as the supporting structure for the radiating element 2 by the ribs 4 (FIGS. 3A and 3B). Specifically, since one end of the rib 6 is inserted into a hole formed in the power feeding element 5, it is possible to position the power feeding element 5 in a plane orthogonal to a longitudinal direction of the rib 6. Since a part of the rib 6 (equivalent to the blades 4b) is set in contact with the power feeding element 5, it is possible to position the power feeding element 5 in the longitudinal direction of the rib 6.

The power feeding element 5 is arranged substantially in parallel to the bottom surface 3a of the ground plate 3 by the rib 6. In other words, the power feeding element 5 and the radiating element 2 are arranged substantially in parallel to each other. As shown in FIG. 2, a space between the power feeding element 5 and the bottom surface 3a is set to be a predetermined value H2.

In this embodiment, the power feeding element 5 is supported by one rib 6. However, the power feeding element 5 can also be supported by plural ribs 6. The number of the ribs 6 and positions where the ribs 6 are arranged can be set as appropriate taking into account the supporting of the power feeding element 5.

As shown in FIG. 1, when the patch antenna 1 is viewed from the front, the power feeding element 5 has length L and width W. The width W is smaller than the length L. The width W is smaller than the diameter of the opening 2b in the radiating element 2. The space H2, the width W, and the length L can be set according to the impedance of the patch antenna 1.

In this embodiment, the power feeding element 5 is arranged such that a longitudinal direction (a longitudinal axis) of the power feeding element 5 is along a radial direction of the radiating element 2. When the patch antenna 1 is viewed from the front, one end 5a of the power feeding element 5 is located on an inner side of the opening 2b. The other end 5b of the power feeding element 5 is connected to a power feeding connector 8 via a wire 7. The power feeding connector 8 is connected to a wireless unit (not shown). Electric power from the wireless unit is supplied to the power feeding element 5.

The power feeding connector 8 is fixed on side walls 3b of the ground plate 3. Specifically, the power feeding connector 8 is attached to a surface on the outer side of the ground plate 3 among the side walls 3b. As shown in FIG. 1, dimensions of the ground plate 3 are set to D1×D2. In this embodiment, the dimension D1 and the dimension D2 are same, but the dimension D1 and the dimension D2 may be set different from each other.

When the patch antenna 1 is viewed from the front, the power feeding connector 8 is arranged at a corner C of the side walls 3b. The corner C of the side walls 3b has a planar section for attaching the power feeding connector 8. The side walls 3b are formed along the outer edge of the bottom surface 3a and extend in the direction substantially orthogonal to the bottom surface 3a. When the patch antenna 1 is viewed from the front, the side walls 3b are arranged in positions surrounding the radiating element 2.

Since the electric power is supplied to the power feeding element 5, it is possible to excite the radiating element 2 and generate a circularly polarized wave in the patch antenna 1. Since the cutouts 2a are provided in the outer circumferential section of the radiating element 2, it is possible to generate a circularly polarized wave. When a linearly polarized wave is generated, the cutouts 2a only have to be omitted. In other words, when the patch antenna 1 is viewed from the front, the radiating element 2 only has to be formed in a circular shape.

In the patch antenna 1 according to this embodiment, in order to reduce the patch antenna 1 in size, the opening 2b is provided in the radiating element 2. As a radius R1 (see FIG. 1) of the opening 2b is set larger, it is possible to set a resonance frequency of the radiating element 2 lower. It is possible to suppress the oscillation amplitude of the radiating element 2 and reduce the patch antenna 1 including the radiating element 2 in size. On the other hand, as the radius R1 of the opening 2b is set larger, the band width of the patch antenna 1 is narrower. It is possible to set the size (the radius R1) of the opening 2b taking into account an application of the patch antenna 1 and external dimensions (D1×D2) required of the patch antenna 1.

For example, when the patch antenna 1 is used in a 953 MHz band, if the external dimensions (D1×D2 shown in FIG. 1) of the ground plate 3 is set to 160×160 [mm] and the radius (R2 shown in FIG. 1) of the radiating element 2 is set to 140 [mm], the radius (R1 shown in FIG. 1) of the opening 2b only has to be set to about 56 mm.

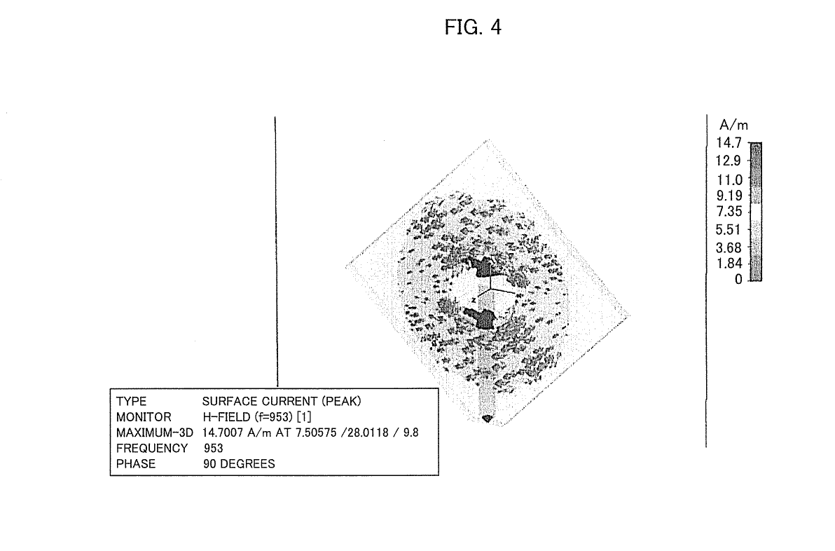

According to this embodiment, when the patch antenna 1 is viewed from the front, one end 5a of the power feeding element 5 is located on the inner side of the opening 2b. Therefore, as shown in FIG. 4, electric currents can be concentrated on the opening 2b. It is possible to concentrate electric fields near the patch antenna 1. As it is seen from FIG. 4, current density in an area along the opening 2b is higher than current density in an area on the outer circumference of the radiating element 2.

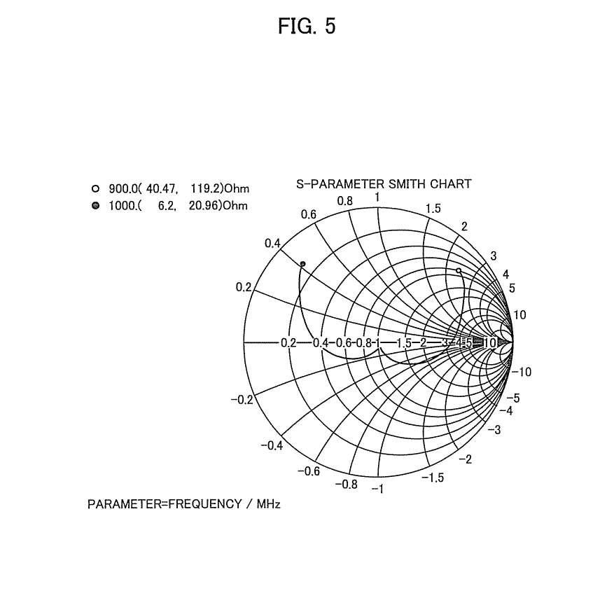

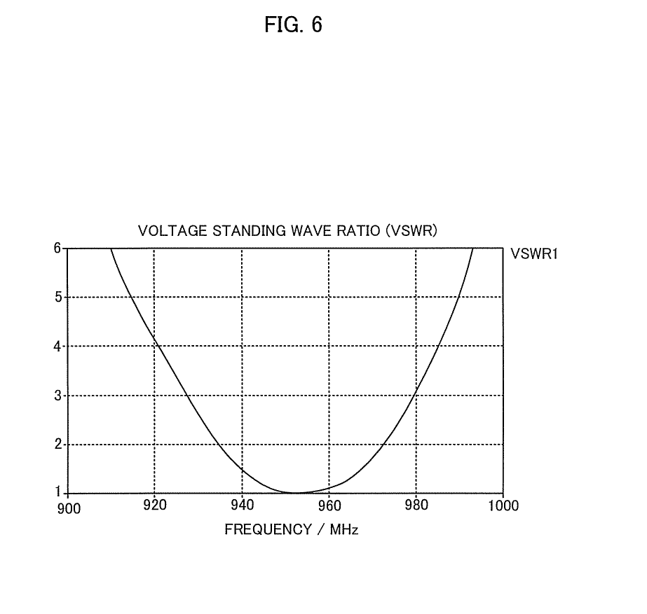

In FIGS. 5 and 6, characteristics of the patch antenna 1 according to this embodiment are shown. FIG. 5 is a graph of a frequency characteristic of the patch antenna 1. FIG. 6 is a diagram of an impedance characteristic of the patch antenna 1.

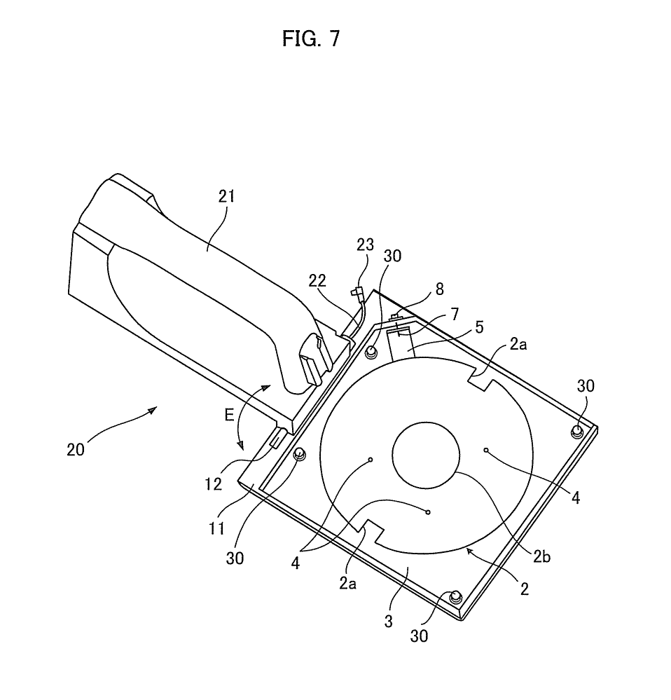

The structure of a portable reader writer including the patch antenna 1 explained above is explained with reference to FIG. 7.

FIG. 7 is an external view of an internal structure of the portable reader writer. Specifically, FIG. 7 is a diagram of the structure of the portable reader writer in a state in which a part of a cover is removed.

The patch antenna 1 having the configuration explained above is fixed to a cover 11. The cover 11 covers the patch antenna 1. In FIG. 7, a part of the cover 11 is shown. Specifically, the cover 11 includes two covers (a lower cover and an upper cover) fixed to each other. In FIG. 7, only one cover (the lower cover) is shown.

As shown in FIG. 7, plural positioning pins 30 are provided in the cover 11. The positioning pins 30 pierce through the bottom surface 3a of the ground plate 3. Since the positioning pins 30 pierce through the bottom surface 3a of the ground plate 3, it is possible to fix the patch antenna 1 to the cover 11. The cover (the lower cover) 11 is formed along the ground plate 3 of the patch antenna 1. An upper cover (not shown) is fixed by bolts (not shown) to the cover (the lower cover) 11 to which the patch antenna 1 is fixed.

A portable reader writer 20 includes a main body 21. The main body 21 has a function of a grip and also has a function of controlling the operation (transmission and reception) of the patch antenna 1. The main body 21 is attached to the cover (the lower cover) 11 to be capable of rotating in a direction of an arrow E shown in FIG. 7. Specifically, a shaft 12 is attached to the cover (the lower cover) 11. The main body 21 is attached to the shaft 12 to be capable of rotating. Specifically, the cover 11 and the main body 21 are connected by a hinge structure.

A cable (the coaxial cable) 22 connected to the wireless unit is arranged on a rotation axis of the main body 21. A connector 23 is provided at an end of the cable 22. The connector 23 is connected to the power feeding connector 8. Since the connector 23 and the power feeding connector 8 are connected, it is possible to feed electric power, which is received from the wireless unit, to the power feeding element 5.

According to this embodiment, it is possible to concentrate electric currents on the opening 2b of the radiating element 2 and concentrate electric fields near the patch antenna 1. Since the electric fields are concentrated, it is possible to efficiently perform transmission and reception of data near the patch antenna 1. Specifically, it is possible to perform writing of data in a tag (not shown) and reading of data from the tag.

While certain embodiments have been described, these embodiments have been presented by way of example only, and are not intended to limit the scope of invention. Indeed, the novel antenna described herein may be embodied in a variety of other forms; furthermore, various omissions, substitutions and changes in the form of the antenna described herein may be made without departing from the spirit of the inventions. The accompanying claims and their equivalents are intended to cover such forms or modifications as would fall within the scope and spirit of the inventions.

What is claimed is:

1. An antenna comprising:
a disk-shaped radiating element having an opening in a center area and configured to radiate a radio wave;
a ground plate configured to support the radiating element and having a surface parallel to the radiating element; and
a power feeding element configured to excite the radiating element, a part of the power feeding element being located on an inner side of the opening when viewed from a predetermined direction orthogonal to a surface on which the radiating element is located.

2. The antenna according to claim 1, wherein current density in an area along the opening of the radiating element is higher than current density in an area on an outer circumference side of the radiating element.

3. The antenna according to claim 1, wherein the power feeding element is arranged along a radial direction of the radiating element when viewed from the predetermined direction.

4. The antenna according to claim 2, wherein the power feeding element is arranged along a radial direction of the radiating element when viewed from the predetermined direction.

5. The antenna according to claim 1, wherein the opening of the radiating element is formed in a circular shape or a regular polygonal shape when viewed from the predetermined direction.

6. The antenna according to claim 2, wherein the opening of the radiating element is formed in a circular shape or a regular polygonal shape when viewed from the predetermined direction.

7. The antenna according to claim 3, wherein the opening of the radiating element is formed in a circular shape or a regular polygonal shape when viewed from the predetermined direction.

8. The antenna according to claim 1, wherein the radiating element has cutouts on an outer circumference when viewed from the predetermined direction.

9. The antenna according to claim 2, wherein the radiating element has cutouts on an outer circumference when viewed from the predetermined direction.

10. The antenna according to claim 5, wherein the radiating element has cutouts on an outer circumference when viewed from the predetermined direction.

11. The antenna according to claim 6, wherein the radiating element has cutouts on an outer circumference when viewed from the predetermined direction.

12. The antenna according to claim 7, wherein the radiating element has cutouts on an outer circumference when viewed from the predetermined direction.

13. The antenna according to claim 8, wherein the cutouts are respectively present in positions opposed to each other across the opening.

14. The antenna according to claim 9, wherein the cutouts are respectively present in positions opposed to each other across the opening.

15. The antenna according to claim 10, wherein the cutouts are respectively present in positions opposed to each other across the opening.

16. The antenna according to claim 11, wherein the cutouts are respectively present in positions opposed to each other across the opening.

17. The antenna according to claim 12, wherein the cutouts are respectively present in positions opposed to each other across the opening.

18. A portable apparatus comprising:
an antenna including: a disk-shaped radiating element having an opening in a center area and configured to radiate a radio wave; a ground plate configured to support the radiating element and having a surface parallel to the radiating element; and a power feeding element configured to excite the radiating element, a part of the power feeding element being located on an inner side of the opening when viewed from a predetermined direction orthogonal to a surface on which the radiating element is located;
a cover configured to cover the antenna; and
a main body connected to the cover.

19. The apparatus according to claim 18, wherein current density in an area along the opening of the radiating element is higher than current density in an area on an outer circumference side of the radiating element.

20. The apparatus according to claim 18, wherein the power feeding element is arranged along a radial direction of the radiating element when viewed from the predetermined direction.
